(19) United States
(12) Patent Application Publication
(10) Pub. No.: US 2021/0106936 A1
(43) Pub. Date: Apr. 15, 2021

(54) UNIVERSAL AIR FILTERS

(71) Applicant: 3M INNOVATIVE PROPERTIES COMPANY, St. Paul, MN (US)

(72) Inventor: Gene B. Portelli, Lake Elmo, MN (US)

(21) Appl. No.: 16/475,638

(22) PCT Filed: Jan. 2, 2018
(86) PCT No.: PCT/US2018/012091

§ 371 Date: Jul. 2, 2019

Related U.S. Application Data
(60) Provisional application No. 62/442,181, filed on Jan. 4, 2017.

(51) Int. Cl. B01D 46/00; B01D 46/12; B01D 46/52; B01D 39/08

(52) U.S. Cl. CPC B01D 46/0016; B01D 46/12; B01D 46/002; B01D 46/521; B01D 2279/50; B01D 2239/0618; B01D 2275/203; B01D 2267/30; B01D 39/08

(57) ABSTRACT

An expandable air filter device. The air filter device includes first and second air filter units and an expansion joint. The air filter units each include a filter media assembly and an outer frame assembly. The filter media assembly defines a perimeter. The outer frame assembly is arranged around the perimeter. The expansion joint is connected to and extends between the outer frame assembly of the first air filter unit and the outer frame assembly of the second air filter unit. In some embodiments, the expansion joint is expandable from a collapsed state to an expanded state. A gap between the first and second air filter units is greater in the expanded state than in the collapsed state, with the expansion joint spanning the gap, serving to impede flow of un-filtered air through the gap during use.

### TECHNICAL FIELD

The present disclosure relates to air filters. More particularly, it relates to expandable air filters, such as expandable HVAC air filters, appropriate for use with multiple, differently sized air filter compartments.

### BACKGROUND

Air filters are commonly used in forced air systems (e.g., residential heating, ventilation and air conditioning (HVAC) systems) in order to remove dust, dirt particles and the like. With many HVAC installations, a disposable air filter is conventionally employed. Such air filters typically include a filter media surrounded and supported by an outer frame. In addition to supporting the filter media, the outer frame rigidly defines a perimeter size and shape of the air filter. Other supporting and/or reinforcing components, such as mesh screens, adhesive beads, etc., may also be included. After a period of use, these filters become dirty or clogged and must be replaced.

To facilitate air filter replacement, HVAC systems conventionally house the air filter within a user-accessible compartment. The air filter is placed into and/or retrieved from the compartment via an access slot. In some instances, the air filter alone is inserted through the slot. In other instances, a separate cabinet is provided into which the air filter is placed, followed by insertion of the filter-loaded cabinet through the access slot. In all instances, upon final insertion of the air filter, a seal is desirably established between the outer frame of the air filter and framework of the compartment so as to prevent airflow around the air filter during use (and thus prevent un-filtered airflow from passing through the HVAC system). User preferred replacement air filters typically have a size that corresponds with the expected size (in terms of height, width and depth) of the HVAC system's air filter compartment.

A number of “standard” HVAC air filter compartment sizes have gained industry acceptance over time and are widely employed. Replacement air filter manufacturers, in turn, attempt to make available for retail purchase air filters corresponding with these standard sizes, allowing a customer to select a particular air filter that should fit their HVAC system's compartment configuration. The rigid outer frame of conventional air filters dictates that the replacement air filter has the same size when shipped to a retailer, when presented to potential purchases, and when installation to the HVAC system is attempted. Because these typical HVAC air filters are thus rather bulky, they undesirably occupy a relatively large volume of space on transportation vehicles and retailer shelves. Further, where the retailer has limited available shelf space and/or desires to display for purchase a large number of differently-sized air filters, only a small number of larger-sized air filters (e.g., deep pleat air filters) can reasonably be presented on the retailer's shelving system. When the small number of a certain air filter size are subsequently removed from the shelf for purchase and the retailer does not consistently replenish the display shelf, it may undesirably appear to the next potential purchaser that the particular air filter size of interest is out of stock.

In addition, a potential customer may not immediately recall with confidence the correct air filter size for their HVAC system while at the retailer's place of business; this uncertainty can be exacerbated when a large number of different air filter sizes are displayed. Rather than purchase a potentially incorrectly-sized air filter, the consumer may instead decide to delay air filter replacement to a later date, potentially leading to inefficient operation of the HVAC system.

Moreover, the actual air filter compartment size associated with a particular HVAC system will oftentimes deviate from the designated “standard” or expected size. For example, the HVAC system manufacturer's specifications may identify an air filter size of 16″×20″×4″, yet the actual air filter compartment is slightly smaller or slightly larger in one or more dimensions. Thus, a purchased 16″×20″×4″ replacement air filter may not be an optimal fit the actual HVAC system compartment (e.g., the purchased air filter may be too large for straightforward insertion, or may be too small and lead to suboptimal HVAC system operation). These circumstances can be frustrating for the user, and can lead to even greater uncertainty when considering the next replacement air filter purchase.

The above-described concerns with conventional replacement HVAC air filters can also arise in other contexts. Many other types of air handling devices or systems (e.g., room air purifiers, window air filters, etc.) make use of a replaceable, rigid-frame air filter, and a plethora of differently-sized replacement air filters are presented for retail purchase. Once again, the relatively large number of differently-sized air filters that must be displayed occupies valuable retail shelf space, and a potential purchaser will oftentimes be unsure as to which size is a best “fit” at the time of purchase.

### SUMMARY

The inventor of the present disclosure recognized a need for an air filter that overcomes one or more of the above-mentioned problems.

Some aspects of the present disclosure relate to a modular air filter device including first and second air filter units and an expansion joint. The air filter units each include a filter media and an outer frame assembly. The filter media defines a perimeter. The outer frame assembly is arranged around the perimeter. The expansion joint is connected to and extends between the outer frame assembly of the first air filter unit and the outer frame assembly of the second air filter unit. In some embodiments, the expansion joint is expandable from a collapsed state to an expanded state. A gap between the first and second air filter units is greater in the expanded state than in the collapsed state, with the expansion joint spanning the gap, serving to impede flow of un-filtered air through the gap during use. In some embodiments, the air filter device further includes exterior framework coupled to the air filter units and configured to selectively retain the air filter units relative to one another in a selected state. In other embodiments, the air filter device includes three or more of the air filter units, and a separate expansion joint connect to and extending between adjacent ones of the air filter units.

Other aspects of the present disclosure relate to a method of installing an air filter device in an air handling device. The method includes receiving an air filter device in a collapsed state. The air filter device includes first and second air filter units and an expansion joint. The air filter units each include a filter media and an outer frame assembly. The filter media defines a perimeter. The outer frame assembly is arranged around the perimeter. The expansion joint is connected to and extends between the outer frame assembly of the first air filter unit and the outer frame assembly of the second air filter unit. The air filter device is expanded from the collapsed state to an expanded state corresponding with the size the air filter compartment provided with the air handling device. In this regard, the step of expanding includes transitioning the first air filter unit away from the second air filter unit and expanding the expansion joint. The air filter device is then inserted into the air filter compartment in the expanded state.

### BRIEF DESCRIPTION OF THE DRAWINGS

FIG. 1A is a perspective view, with portions shown in block form, of an air filter device in accordance with principles of the present disclosure in a collapsed state;

FIG. 1B is a perspective view of the air filter device of FIG. 1A in an expanded state;

FIG. 1C is a perspective view of the air filter device of FIG. 1A in another expanded state;

FIG. 2A is a perspective view of a filter media assembly useful with the air filter of FIG. 1A;

FIG. 2B is an enlarged cross-sectional view of a portion of the filter media assembly of FIG. 2A, taken along the line 2B-2B;

FIG. 3A is a simplified front plan view of the air filter device of FIG. 1A in the collapsed state;

FIG. 3B is a simplified front plan view of the air filter device of FIG. 3B in an expanded state;

FIG. 4A is a simplified front plan view of another air filter device in accordance with principles of the present disclosure and in an expanded state;

FIG. 4B is a simplified front plan view of another air filter device in accordance with principles of the present disclosure and in an expanded state; and

FIG. 5 is a simplified perspective view, with portions shown in block form, of an air filter device kit in accordance with principles of the present disclosure.

### DETAILED DESCRIPTION

The present disclosure generally relates to an air filter device including two or more air filter units that are or can be attached to one another, resulting in a modular and adaptable filtration system. In some embodiments, at least a portion of the air filter device is capable of expansion in one or more dimensions such that it is capable of moving from a collapsed state to an expanded state. The use of multiple air filter units that can be attached to one another and/or be expanded to a desired size permits the user to build or create an air filter device of a desired size. It also reduces the burden on a retailer to carry or stock a large number of differently sized filters. In some embodiments, the air filter device is configured for use with a conventional HVAC system. Expansion of the air filter device (or a portion thereof) permits a user to closely match the size of the air filter device to the size of the air filter compartment, which results in a good seal between the air filter device and the air filter compartment.

Air Filter Device

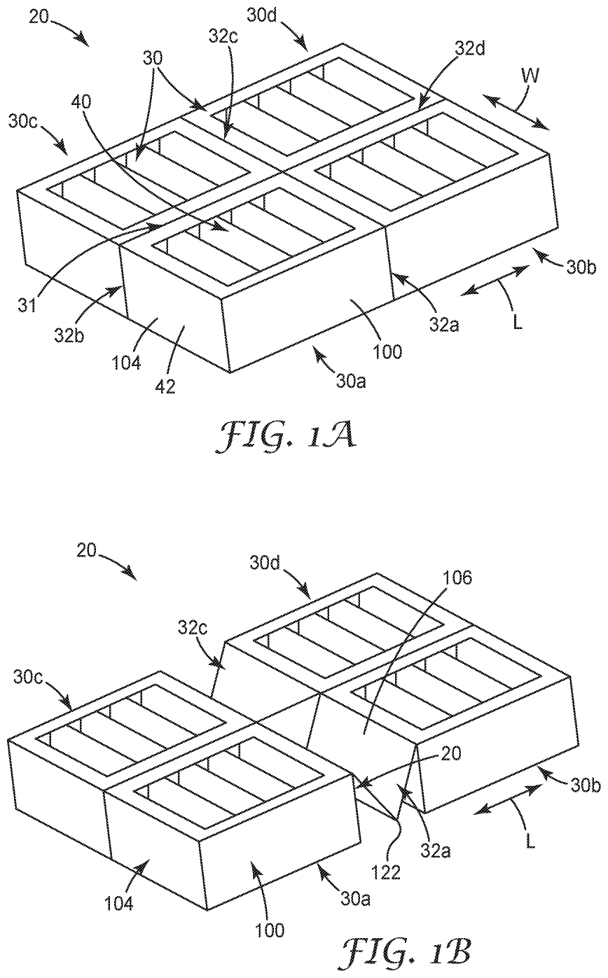

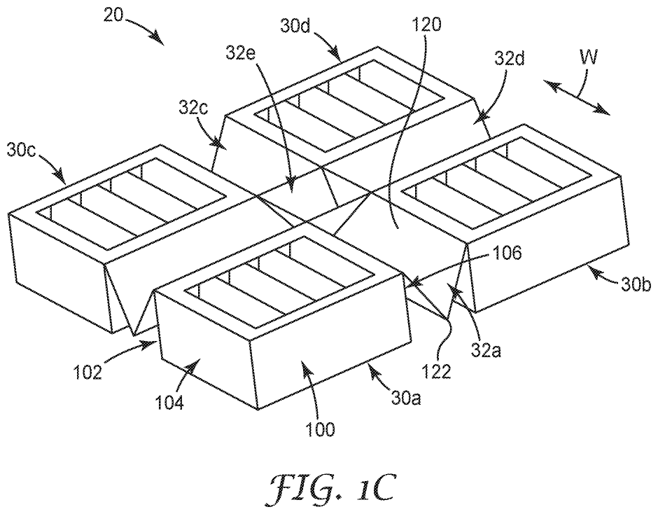

One embodiment of an air filter device 20 is shown in FIGS. 1A-1C. The air filter device 20 is generally configured to be manually expandable by a user from a collapsed state (shown in FIG. 1A) in one or both of a length direction L and a width direction W to an expanded state, two non-limiting examples of which are shown in FIGS. 1B and 1C. The air filter device 20 can be configured to permit independent expansion in both the length and width directions.

The specific air filter device 20 shown in FIGS. 1A-1C includes four air filter units 30a-30d attached to one another by one or more attachment mechanisms. The exemplary attachment mechanism of FIGS. 1A-1C is expandable. The exemplary attachment mechanism of FIGS. 1A-1C is expandable in at least one dimension and is referred to herein as an expansion joint, and the four expansion joints of FIGS. 1A-1C are referred to as first-fourth expansion joints 32a-32d. The expansion joints 32a-32d of FIGS. 1A-1C are connected to and extend between at least two of the air filter units 30a-30d and are configured to expand when the air filter device 20 (or a portion thereof) is transitioned from a collapsed state to an expanded state. Expansion of the air filter device 20 from a collapsed state to an expanded state involves a user separating or manipulating at least two of the air filter units 30 in directions away from one another, causing the corresponding expansion joint 32 to expand.

In some embodiments, the expansion joints 32a-32d can also contract when the air filter device 20 is transitioned from an expanded state to a collapsed state. Contraction of the air filter device 20 from an expanded state to a collapsed state involves a user drawing or otherwise manipulating at least two of the air filter units 30 toward one another, causing the corresponding expansion joint 32 to contract. In typical embodiments, adjacent air filter units are in close proximity in the collapsed state. In some embodiments, portions of a given expansion joint may even come into contact as the air filter device is drawn into the collapsed state.

In the specific embodiment shown in FIGS. 1A-1B, the expansion joints 32a-32d provide a continuous surface between the separated air filter units 30 (e.g., in the exemplary expanded state of FIG. 1B, the first expansion joint 32a provides a continuous surface over the spacing between the first and second air filter units 30a, 30b). As used herein, the term “continuous surface” with respect to an expansion joint refers to a situation where, when installed in an expanded state, the expanded expansion joint(s) 32 has a continuous surface that impedes the flow of un-filtered air through the gap or spacing between a spaced apart pair of the air filter units 30. In some embodiments, the continuous surface is integral or a single surface, and in some embodiments, the continuous surface includes multiple surfaces. The presence of a continuous surface can be advantageous since it permits the air filter device to maintain air pressure and/or to capture particulate matter in the air flow incident upon the air filtration media in the air filter device. Some embodiments do not include a continuous surface.

The air filter device 20 can optionally include a frame 34 (not shown) capable of securing the air filter device 20 and/or the air filter units 30 in a selected expanded state.

In some embodiments, the attachment mechanism(s) and/or expansion joint(s) is attached to two or more air filter units. For example, an attachment mechanism or single expansion joint 32 is connected to two or more air filter units 30 (e.g., a single expansion joint body can extend between and interconnect both the first and second air filter units 30a, 30b and/or the third and fourth air filter units 30c, 30d). In such embodiments, the entire air filter device can be sold or manufactured as a unit and the user needs only to expand it to make it usable in an HVAC or other air filtration unit.

In other implementations, the air filter units are sold with or separately from the attachment mechanism(s) (including expansion joint(s)). In such embodiments, the attachment mechanism(s) (including expansion joint(s)) can be attached to the air filter units by any desired mechanism, including, for example, mechanical fasteners (e.g., adhesive backed hook and/or loop fasteners available from 3M Company, St. Paul Minn.) or adhesives. In other such implementations, at least one expansion joints may be bonded by the manufacturer to one or more of the air filter units by e.g., by melt bonding, adhesive bonding, ultrasonic welding, and so forth.

The specifics of FIGS. 1A-1C are merely exemplary. For example, any desired number (two or greater), type, or size of air filter units can be used, and any desired number, size, or type of attachment mechanisms may be used.

Air Filter Units

The air filter unit(s) used in any of the embodiments herein can be of any desired size, shape, or construction. In some embodiments, the air filter units in a single air filter device are of substantially the same or similar size, construction, or shape. In some embodiments, the air filter units in a single air filter device vary in size, construction, or shape.

Each air filter unit includes (1) filter media 40 and (2) optionally, an outer frame assembly 42 (identified for the first air filter unit 30a in FIG. 1A). Both of these components are described in detail below.

The air filter unit can optionally include one or more additional components or structures applied or assembled to the filter media 40, such as, for example, a wire mesh, a screen, one or more adhesive strands, etc., all of which can be adjacent or bonded to the filter media 40 in order to enhance the pleatability thereof or that may be pleated along with the filter media 40 itself. These structures may impede re-collapsing of the pleats in pleated filter media. The ordinary artisan will appreciate that any of these features may be used particularly with pleated filter media to support the media and thus to minimize any tendency of the pleats to unacceptably deform (e.g., billow, collapse, and so on) under the air pressures typically encountered, e.g., in a residential HVAC system. Various additional components for enhancing filtration media stability are described, for example, in International Publication No. 2015/054097 (Castro et al.) and U.S. Pat. No. 6,858,297 (Shah et al.), both of which are incorporated in their entirety herein.

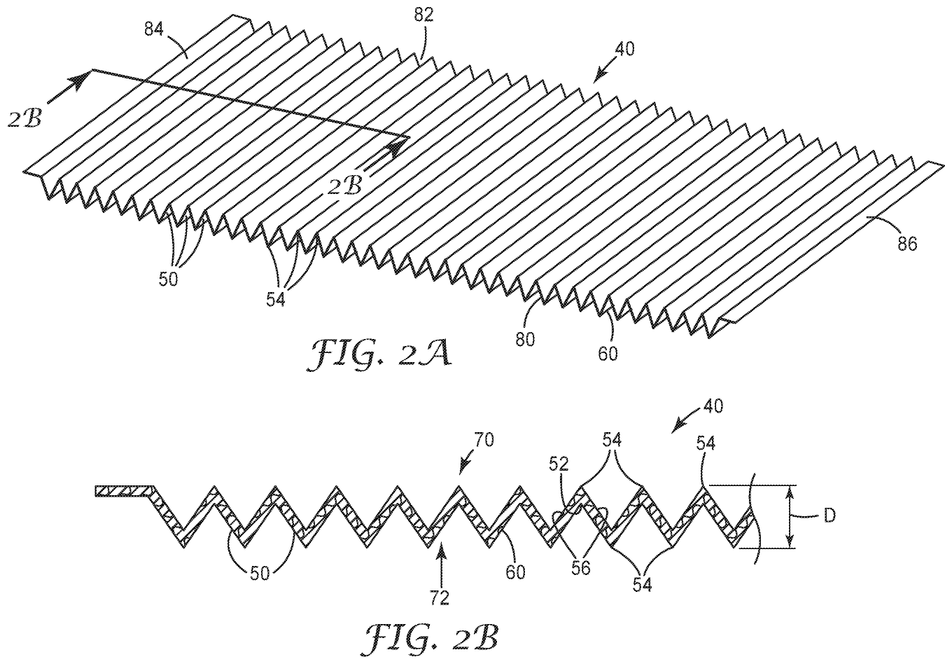

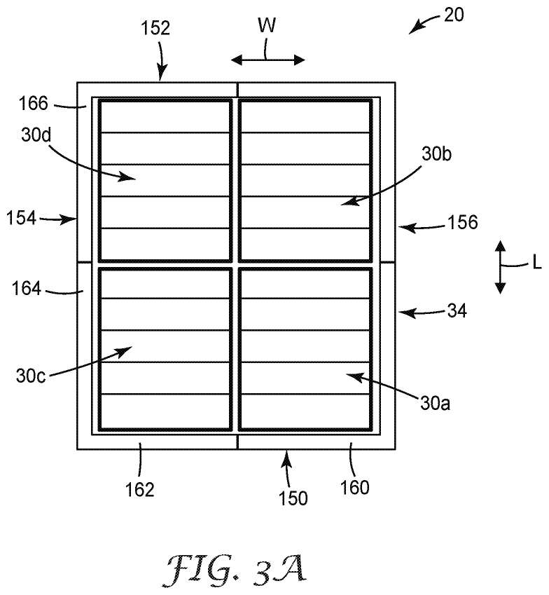

In some embodiments, one or more of the air filter units 30 include one or more grid or grill structures extending over a corresponding one of the major faces 70, 72 (FIG. 2B) of the corresponding filter media 40. The grill(s) or grid(s) can be formed of any desired material, including, for example, material similar to that of the outer frame assembly 42. In some embodiments, the grill(s) or grid(s) can be integrally formed with, and folded relative to, the outer frame assembly 42. In other embodiments, the grill(s) or grid(s) (or sub-components thereof) can be separately formed and subsequently attached to the outer frame assembly 42 via known or available fixation mechanisms.

Filter Media

The filter media 40 can be pleated or unpleated. FIGS. 2A and 2B show an exemplary pleated filter media including a web or sheet at least a portion of which has been folded to form a configuration comprising rows of generally parallel, oppositely oriented folds. The pleated filter media 40 of FIGS. 2A and 2B includes a plurality of pleats 50 each including a fold line 52 defining a pleat tip 54 and a pair of adjacent panels 56. The optional pleats can be formed using various methods and components as are well known in the art, e.g., to form a pleated filter for use in applications such as air filtration, for example those described in U.S. Pat. No. 6,740,137 to Kubokawa et al. and U.S. Pat. No. 7,622,063 to Sundet et al., the entire teachings of both of which are incorporated herein by reference.

In other embodiments of the present disclosure, the filter media 40 need not have a pleated construction. The filter media associated with the flat version of the filter media assembly can be formed of any of the materials described below, and is formatted to maintain a prescribed size and shape. The air filter units of the present disclosure are equally useful with pleated-type air filters and unpleated or flat-type air filters.

The filter media 40 can be self-supporting or non-self-supporting. As used herein, the term “self-supporting” with respect to filter media describes filter media that satisfies at least one of the following conditions: (1) a filter media or web that is deformation resistant without requiring stiffening layers, adhesive or other reinforcement in the filter media web; or (2) the filter media generally maintains its shape when subjected to an airstream as described, for example, in U.S. Pat. No. 7,169,202 (Kubokawa), the entire teachings of which are incorporated herein by reference; or (3) a web or media having sufficient coherency and strength so as to be drapable and handleable without substantial tearing or rupture. As used herein, the term “non-self-supporting” can denote an air filter media that does not satisfy at least one of the above conditions.

The pleated filter media can have any desired pleat depth and distance between adjacent pleats. Some exemplary pleat depths include 5 inches, 4.5 inches, 4 inches, 3 inches, 2 inches, 1 inch, and 0.5 inches. Other depths, greater or smaller, are also acceptable. The distance between any given two pleats can be adjusted. For example, the distance between any two pleats can vary between about 0 (i.e., the pleats are essentially positioned directly adjacent to each other) and about 5 inches.

The particular filter media 40 used is not critical to the present disclosure so long as the resultant air filter unit has the desired filtration characteristics. Filter media can be, for example, nonwoven fibrous media formed of, for example, thermoplastic or thermosetting materials such as polypropylene, linear polyethylene, and polyvinyl chloride; porous foams; nonwovens; paper; fiberglass; a high loft spunbonded web (such as described, for example, in U.S. Pat. No. 8,162,153 (Fox et al.), the entire teachings of which are incorporated herein); a low loft spunbonded web (such as those described in U.S. Pat. No. 7,947,142 (Fox et al.), the entire teachings of which are incorporated herein) or the like. In yet other embodiments, nonwoven webs useful with the filter media 40 are generated by other techniques and/or have other characteristics, such as the meltblown nonwoven webs disclosed in U.S. Pat. No. 6,858,297 (Shah et al.) (mentioned above). Other non-limiting example of useful nonwoven web formats include bi-modal fiber diameter meltblown media such as that described in U.S. Pat. No. 7,858,163 (Angadjivand et al.), the entire teaching of which are incorporated herein by reference. In various embodiments, nonwoven web may be, e.g., a carded web, an air-laid web or, a spun-laced web, and so on. In other embodiments, nonwoven web 200 may be a multilayer web, e.g., a so-called spunbond-meltblown-spunbond (SMS) web or the like. The fibers of nonwoven web may be arranged (whether by bonding fibers to each other and/or physically entangling fibers with each other, or some combination thereof) to form, e.g., a handleable web by way of melt-bonding, adhesive bonding, needle-punching, stitch-bonding, and so on, as desired.

In some embodiments, the filter media 40 comprises a nonwoven web that can have random fiber arrangement and generally isotropic in-plane physical properties (e.g., tensile strength), or, if desired, may have aligned fiber construction (e.g., one in which the fibers are aligned in the machine direction as described in U.S. Pat. No. 6,858,297 (Shah et al.), the teachings of which are incorporated herein by reference) and anisotropic in-plane physical properties. Some or all of the fibers comprising the nonwoven webs useful for the filter media 40 can be multicomponent fibers having at least a first region and a second region, where the first region has a melting temperature lower than the second region. Some suitable multicomponent fibers are described, for example, in U.S. Pat. No. 7,695,660 (Berrigan et al.), U.S. Pat. No. 6,057,256 (Krueger et al.), U.S. Pat. No. 5,597,645 (Pike et al.), U.S. Pat. No. 5,662,728 (Groeger), U.S. Pat. Nos. 5,972,808 and 5,486,410 (Groeger et al.), the teachings of each of which are incorporated herein by reference in their entireties.

An electrostatic charge can optionally be imparted into or on to material(s) of the filter media 40. Thus, the filter media 40 can be an electret nonwoven web. Electric charge can be imparted to the filter media 40 in a variety of ways as is well known in the art, for example by hydrocharging, corona charging, tribocharging, etc. (e.g., as described in U.S. Pat. No. 7,947,142 (mentioned above)). In other embodiments, the filter media 40 is not electrostatically charged. Additives may also be included in the fibers to enhance the web's filtration performance, mechanical properties, aging properties, surface properties or other characteristics of interest. Representative additives include fillers, nucleating agents (e.g., MILLAD™ 3988 dibenzylidene sorbitol, commercially available from Milliken Chemical), UV stabilizers (e.g., CHIMASSORB™ 944 hindered amine light stabilizer, commercially available from Ciba Specialty Chemicals), cure initiators, stiffening agents (e.g., poly(4-methyl-1-pentene)), surface active agents and surface treatments (e.g., fluorine atom treatments to improve filtration performance in an oily mist environment as described in U.S. Pat. Nos. 6,398,847, 6,397,458, and 6,409,806 to Jones et al.). The types and amounts of such additives will be apparent to those skilled in the art.

As shown in FIG. 2B, the filter media 40 includes opposing first and second major faces 70, 72. A perimeter of the filter media assembly 40 can be defined by opposing first and second side edges 80, 82 and opposing first and second end edges 84, 86. In some embodiments, the perimeter can have the rectangular shape (that is specifically inclusive of a square shape) shown, but any desired shape can be used.

Outer Frame Assembly

In some embodiments, the outer frame assembly 42 surrounds a perimeter of the filter media 40. In some embodiments, the outer frame assembly 42 structurally supports the filter media 40. For example, in some embodiments, the outer frame assembly 42 of the first air filter unit 30a supports the corresponding filter media 40 independent of any of the other air filter units (e.g., the second-fourth air filter units 30b-30d) and of the optional exterior framework 34). In other embodiments, a number of air filter units 30(n)-30(n+z) can share one of more portions of a given frame assembly (e.g., adjacent air filter units may share an edge such that the outer frame assemblies are essentially monolithic). As an example, the otherwise discrete outer frame assemblies 30a and 30c (and for that matter, 30d and 30b) in FIG. 1B could share a common frame element 31, such that the relevant air filter units are not separable in the width direction W.

The outer frame assembly 42 can assume a variety of forms and is generally configured to surround the perimeter of the filter media 40 (e.g., as identified in FIG. 1A, the outer frame assembly 42 of the first air filter unit 30a surrounds the perimeter of the filter media 40 of the first air filter unit 30a; the outer frame assembly 42 of the second air filter unit 30b is distinct from the first air filter unit 30a, and surrounds the perimeter of the filter media 40 of the second air filter unit 30b). The outer frame assembly 42 is constructed to robustly support the corresponding filter media 40 in the collapsed state as well as in any of the expanded states described herein, including the outer frame assembly 42 maintaining a desired size and shape when subjected to expected forces of a designated end-use environment (e.g., the outer frame assembly 42 will maintain its structural integrity during installation to an HVAC system air filter compartment and to normal HVAC system airflow and operation). The outer frame assembly 42 of FIGS. 1A-1C includes or defines opposing first and second side frame structures 100 and 102 and opposing first and second end frame structures 104 and 106. The side frame structures 100, 102 are generally configured to cover a respective one of the corresponding first and second side edges 80, 82 (FIG. 2A) of the filter media assembly 30, whereas the end frame structures 104, 106 are generally configured to cover a respective one of the first and second end edges 84, 68 (FIG. 2A).

The frame structures 100, 102, 104 and 106 can have any format conducive to use as part of the outer frame assembly 42, and can be substantially identical or different. In some embodiments, one or more of the frame structures 100, 102, 104, 106 can consist of a single frame member or body. A major portion of the outer frame assembly 42 may be formed, e.g., by folding of a single frame piece, by the assembling of multiple pieces to each other, and so on. In many embodiments, any one of or all four major frame structures 100, 102, 104, 106 may each comprise upstream and downstream flanges and inner and outer sidewalls/panels and foldable connections there between. Exemplary frame constructions are described in, for example, U.S. Pat. No. 7,503,953 (Sundet et al.), U.S. Pat. Nos. 8,702,829, 8,979,966 (Lise et al.), and International Publication No. 2015/054097 (Castro et al.), all of which are incorporated by reference herein.

The outer frame assembly 42 can be formed from any material capable of maintaining its structural integrity during use. For example, the outer frame assembly 42 can be constructed of cardboard, paperboard, plastic (e.g., thermoformed plastic), metal, etc.

Attachment Mechanism

The attachment mechanism attaches to and connects two or more air filter units. In some embodiments, the attachment mechanism has fixed dimensions during use (e.g., the attachment mechanism is dimensionally stable during assembly or in an HVAC system). In some embodiments, the attachment mechanism is expandable. In such embodiments, the attachment mechanism is referred to herein as an expansion joint 32 and is configured to be readily expandable from a collapsed state to an expanded state. The attachment mechanism can assume a variety of forms compatible with the particular format of the air filter units 30. A single attachment mechanism and/or expansion joint 32 can be employed to interconnect two or more pairs of the air filter units 30. Alternatively, two or more attachment mechanisms and/or expansion joints can be employed between an adjacent pair of the air filter units 30. Where the air filter device 20 includes two or more attachment mechanisms, the attachment mechanisms in a single air filter device can have similar, identical, or different constructions.

The attachment mechanism can include any material or structure capable of connecting adjacent air filter units and of working in an HVAC system or other air filtration device when in operation. Some exemplary materials include, for example, a nonwoven material (such as any of the nonwoven materials described above with respect to the filter media), an elastic material (e.g., thin rubber, etc.), a fabric, adhesives, hook-and-loop fastening elements, thermoplastic films, cardboard, paperboard, etc. In some embodiments, the attachment mechanism includes a material that minimizes un-filtered air flow at levels akin to, equal to, or less than that of the filter media 40. In some embodiments, the attachment mechanism prevents or minimizes the passage of air through the attachment device during operation of the air filter device.

In implementations where the attachment mechanism includes an otherwise continuous film (e.g., certain thermoplastic films), the extent to which air flow is reduced or minimized can be modified by perforations, fenestrations, slits, or other apertures through at least a portion of the film.

The ability of the attachment mechanism to be readily expanded from a collapsed state to an expanded state can be incorporated into the attachment mechanism in any of a variety of ways. In some embodiments, for example, the attachment mechanism includes one or more fold lines 122 (identified for the first expansion joint 32a in FIGS. 1B and 1C). In related embodiments, the attachment mechanism is foldable and/or pleated filter media. Alternatively, or in addition, the attachment mechanism can be elastic or stretchable (e.g., a stretchable fabric). In yet other embodiments, the attachment mechanism need not include or define a discernible fold line. For example, an expansion joint can be formed of a material that is sufficiently stretchable to readily attain a desired expanded state when subjected to normal stretching forces applied by a user, and excess material can be compressed or “bunched” between the corresponding air filter units 30 in the collapsed state of the air filter device 20.

FIG. 1C shows an air filter device 20 including the first-fourth expansion joints 32a-32d as well as a fifth expansion joint or patch 32e across the first-fourth expansion joints 32a-32d. The fifth expansion joint 32e connects or extends across or between the first-fourth expansion joints 32a-32d. The fifth expansion joint 32e can have any of the constructions described herein, and can combine with the first-fourth expansion joints 32a-32d to prevent unfiltered airflow from passing through the air filter device 20.

While each of the expansion joints 32a-32d are illustrated in the non-limiting embodiment of FIGS. 1A-1C as being separate bodies, other constructions are also acceptable. For example, a single expansion joint 32 can be employed to interconnect two or more pairs of the air filter units 30 (e.g., an expansion joint body can extend between and interconnect both the first and second air filter units 30a, 30b and the third and fourth air filter units 30c, 30d, promoting expansion in the length direction L). Conversely, two or more expansion joints can be employed between an adjacent pair of the air filter units 30.

Exterior Framework

Where provided, optional exterior framework 34 can provide one or more of the following functions: (1) permitting transitioning of the air filter device 20 or the air filter units 30 from a collapsed state to an expanded state; and/or (2) supporting or retaining the air filter units 30 relative to one another in a selected expanded state.

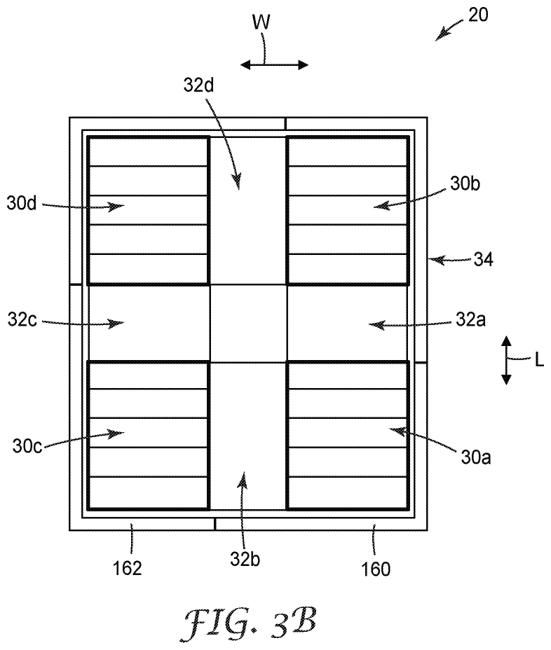

FIG. 3A provides one non-limiting representation of the exterior framework 34 assembled to the air filter units 30a-30d and in a collapsed state of the air filter device 20. The exterior framework 34 can include multiple components that are slidably connected to another at opposing ends 150, 152 and opposing sides 154, 156 of the air filter device 20. For example, FIG. 3A depicts the exterior framework 34 as including first and second legs 160, 162 at the first end 150. The legs 160, 162 are slidably connected to one another (e.g., the legs 160, 162 can have a complementary U or C-shaped channels, with one or more dimensions of one leg slightly exceeding the corresponding dimensions of the other). In the depicted embodiment, at least a portion of the leg 160 is received in a channel or other similar structure defined at least partially by leg 162, though the opposite construction (e.g., leg 162 is received in leg 160) is equally suitable.

Similar constructions can be provided at the opposing end 152 as well as at the opposing sides 154, 156 (e.g., FIG. 3A depicts the exterior framework 34 as including first and second legs 164, 166 at the first side 154). The exterior framework 34 can be assembled to the air filter units 30a-30d in various manners that do not overtly impeded desired manipulation of the air filter units 30a-30d relative to one another in transitioning the air filter device 20 to an expanded state. For example, relative to the first end 150, the first leg 160 is attached to the first air filter unit 30a, but is not directly attached to the third air filter unit 30c; conversely, the second leg 162 is attached to the third air filter unit 30c, but is not directly attached to the first air filter unit 30a. With this arrangement, then, attachment of the legs 160, 162 to the corresponding air filter unit 30a, 30c does not prevent or impeded transitioning of the first and third air filter units 30a, 30c away from one another (in the width direction W). Similar relationships can be established by the exterior framework 34 relative to others of the air filter units 30a-30d so as to not impede transitioning of the air filter units 30 relative to one another in the length direction L. The exterior framework 34 readily permits expansion of the air filter device 20 from the collapsed state of FIG. 3A to an expanded state, one example of which is reflected by FIG. 3B (in which the air filter device 20 has been expanded in both the length and width directions L, W).

Other exterior framework 34 constructions may be configured to impede expansion of the air filter device 20 along one of the length and width directions L, W. For example, opposing side 154 could include monolithic or fused leg portions 164, 166, effectively inhibiting the expansion of the air filter units 30d and 30c in the length direction L. Alternatively, the first end 150 can include monolithic or fused leg portions 160, 162, effectively inhibiting the expansion of the air filter units 30a and 30c in the width direction W.

The exterior framework 34, where provided, can optionally include one or more mechanisms or structures that selectively lock the exterior framework 34, and thus the air filter unit 20, in a desired expanded state or footprint. The locking device(s) can assume various forms, including mechanical fasteners, hook-and-loop fasteners, adhesives, etc. In other embodiments, the locking devices can be incorporated into the legs of the exterior framework 34 (e.g., the first leg 160 and the second leg 162 can incorporate a complementary tab/slot design whereby a tab carried by the first leg 160 can be inserted into one of a plurality of slots formed along a length of the second leg).

Additional exemplary embodiments of exterior framework 34 and aspects thereof are described in, for example, International Publication No. WO2015/143326 (Zhang et al.) as well as U.S. Pat. No. 6,955,702 (Kubokawa et al.) and U.S. Pat. No. 8,702,829 (Lise et al.), and U.S. Patent Publication Nos. 2015/0267927 (Zhang et al.), and 2015/265957 (Fox), the disclosure of all of which are incorporated by reference herein.

Methods of Installation and Use

Returning to FIGS. 1A-1C, prior to installation of the air filter device 20 to an air filter compartment of the air handling device in question, a user can first evaluate or compare a size of the actual air filter compartment relative to a size of the air filter device 20 in the collapsed stated. Under circumstances where the comparison implicates the desirability of expanded the air filter device 20 in one or both of the length and width directions L, W, the user then effectuates the desired expansion by transitioning the corresponding air filter units 30 away from one another. For example, where the comparison indicates that the length of the air filter device in the collapsed state is less than the length of the air filter compartment, the first and third air filter units 30a, 30c can be manually pulled away or separated from the second and fourth air filter units 30b, 30d in the length direction L, akin to the expanded state of FIG. 1B. Additionally, or alternatively, the first and second air filter units 30a, 30b can be manually pulled away or separated from the third and fourth air filter units 30c, 30d to effectuate an expansion in the width direction W as deemed desirable by the end user. Once a desired or selected expanded state is achieved, the exterior framework 34 (where provided) can be actuated or otherwise “locked” to maintain the air filter units 30a-30d relative to one another in the expanded state. The air filter device 20, in the selected expanded state, can then be installed to the air filter compartment. When subjected to expected airflow, the individual air filter units 30a-30d each filter particles and other contaminants in pursuant to the design characteristics of the corresponding filter media assembly, with the expansion joints 32a-32d preventing unfiltered air from progressing through the spacing between the individual air filter units 30a-30d. In yet other embodiments, one or more expansion units (not shown) can be assembled to the air filter device 20 to further improve a fit with air filter compartment, such as any of the expansion units described in International Publication Number WO2017/053177 (Gregerson et al.), the entire teachings of which are incorporated herein by reference.

The air filter devices of the present disclosure are useful in a wide variety of air handling applications. In some embodiments, the air filter device 20 can be configured for use with HVAC systems. With these and other embodiments, a user is afforded the ability to custom fit the air filter device 20 (via expansion in one or both of the length and width directions L, W) to an exact size of the air filter compartment provided with the user's actual HVAC system. In related embodiments, the air filter device 20 can be provided as a universal product, appropriate for use with a number of different HVAC systems that might otherwise have slightly different air filter compartment dimensions. By way of example, different HVAC system manufacturers may each specify to a user that a 16″×20″×4″ air filter should be used with their HVAC system, yet the actual air filter compartment is sized and shaped to provide a best fit with slightly different dimensions (e.g., 16″×19″×4″; 16″×21″×4″; 15″×20″×4″; 17″×20″×4″; etc.). With this in mind, the air filter device 20 of the present disclosure can be configured such that in the collapsed state, outer length and width dimensions correspond with the smallest expected air filter compartment dimensions utilized by several different HVAC system manufacturers. Continuing with the above example, then, the air filter device 20 can be configured to have outer dimensions of 15″×19″×4″ in the collapsed state, and promoted to potential users as being acceptable for use with any HVAC system requiring a 16″×20″×4″ air filter. Upon evaluating the size of the actual air filter compartment, the user can then, if necessary, expand the 15″×19″×4″ air filter device in one or both of the length and width directions L, W as described above, transitioning the air filter device 20 to an expanded state having dimensions corresponding with those of the actual air filter compartment. Similar benefit can also be provided with other air filtration applications, such as air purifiers, window air filters, etc.

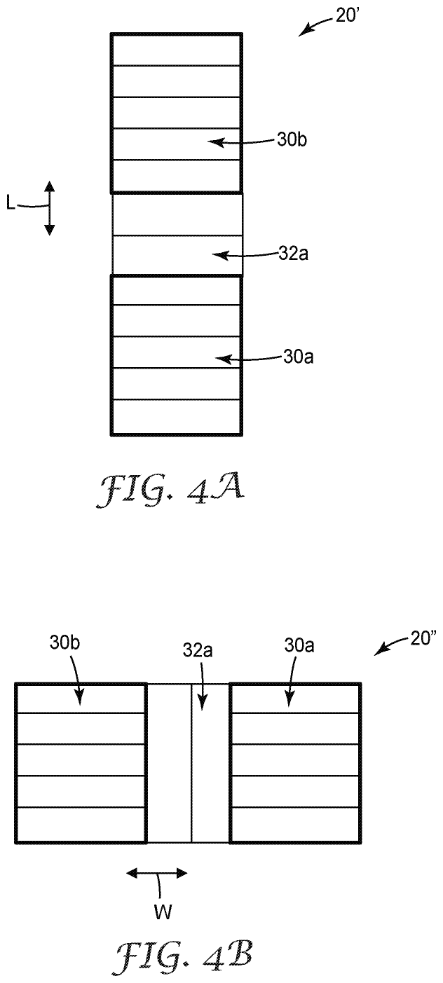

It will be understood that the air filter devices of the present disclosure need not necessarily be expandable in both the length direction L and the width direction W; beneficial air filter devices in accordance with principles of the present disclosure can instead be expandable in only the length direction L or in only the width direction W. For example, the air filter device 20′ of FIG. 4A includes the first and second air filter units 30a, 30b connected to one another by the first expansion joint 32a as described above. The air filter device 20′ is configured to be expandable in the length direction L. Similarly, the air filter device 20″ of FIG. 4B include the first and second air filter units 30a, 30b connected to one another by the first expansion joint 32a as described above. The air filter device 20″ is configured to be expandable in the width direction W.

Air Filter Device 20 Delivery Condition and Assembly

Returning to FIGS. 1A-1C, regardless of the exact number of the air filter units 30 and of the expansion joints 32 utilized with a particular end-use format of the air filter device 20, the air filter devices of the present disclosure can be provided or delivered to an end user in a delivery condition that may or may not require assembly of various components by the end user prior to installation to an air filtration device's filter compartment. For example, FIGS. 1A-1C illustrates an assembled delivery condition of the air filter device 20, and includes the expansion joint(s) 32 pre-assembled or pre-attached to the corresponding pair of adjacent air filter units 30 (e.g., with the non-limiting example air filter device 20 of FIGS. 1A-1C in which four of the air filter units 30a-30d are included, the first expansion joint 32a is pre-assembled to both of the first and second air filter units 30a, 30b; the second expansion joint 32b is pre-assembled to both of the first and third air filter units 30a, 30c; etc.). Where provided, the exterior framework 34 as described above can also be pre-assembled to the air filter units 30 as received by the user in the assembled delivery condition; alternatively, the assembled delivery condition can include the end user assembling the exterior framework 34 to the air filter units 30 as described above.

Where the air filter device 20 is provided to an end user in the assembled delivery condition described above, aspects of the present disclosure optionally afford an air filter manufacturer the ability to produce a wide array (e.g., different sizes and/or shapes) of air filter devices based on a single size (or relatively small number of different size) air filter unit. The air filter manufacturer could, for example, produce only one size air filter unit at the manufacturing plant, and then combine the so-produced air filter units (using the expansion joint(s) as described above) as appropriate to create an essentially unlimited range of resultant air filter device sizes between a pre-defined minimum and maximum limits. With this modular approach, the single size air filter unit can have dimensions on the order of 8″×10″ in some embodiments.

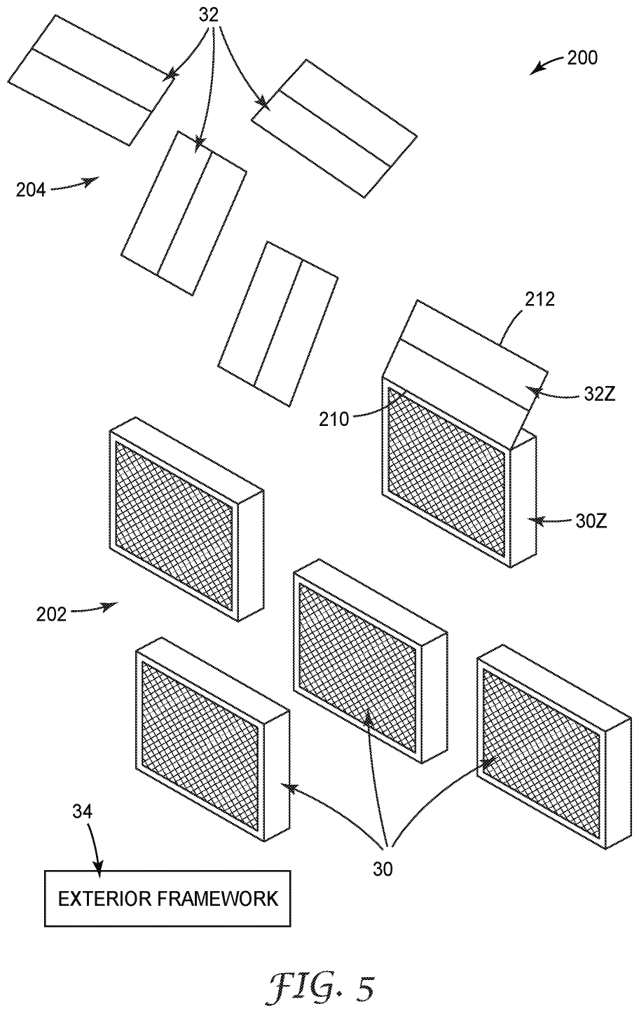

In other embodiments of the present disclosure, two (or more) of the air filter units 30 can be provided to an end user separate from one another (e.g., not directly connected by a shared one of the expansion joints 32) in a modular delivery condition. FIG. 5 illustrates one non-limiting example of a modular delivery condition in accordance with principles of the present disclosure. In some embodiments, the modular delivery condition can optionally be viewed as a kit 200 of parts provided to or obtained by an end user. The kit 200 includes a set 202 of the air filter units 30 as described above. In the modular delivery condition, the air filter units 30 are separate from one another. While FIG. 5 reflects the set 202 as including five of the air filter units 30, any other number, greater or lesser, is equally acceptable. Regardless of the exact number, the air filter units 30 of the set 202 can be obtained by an end user as part of the kit 200 (e.g., all of the air filter units 30 are provided to the end user as part of a single purchase), or ones of the air filter units 30 can be obtained on an individual basis (e.g., an end user can separately purchase or obtain each of the air filter units 30). A set 204 of separated attachment mechanisms (here expansion joints 32) can also be provided in the modular delivery condition (and may include more or less than five of the expansion joints 32 of FIG. 5), either as part of the kit 200 or as obtained by the end user on an individual basis. The optional exterior framework 34 can also be provided in the modular delivery condition, either as part of the kit 200 or as obtained by the end user on an individual basis.

The optional modular delivery condition formats of the present disclosure allow an end user to construct an expandable air filter device having a size and shape generally approximating (e.g., slightly less than) the air filter compartment to which the air filter device will be installed. For example, each of the air filter units 30 can have a relatively small footprint or size (e.g., on the order of 10″×8″). With a number of the relatively small air filter units 30 on-hand, the end user can evaluate or estimate the shape and size of the air filter compartment, and then select and arrange an appropriate number of the air filter units 30 in accordance with the estimate. The resultant air filter device can have any of the constructions described above (e.g., the constructions or arrangements of FIGS. 1A-1C, 4A, 4B) or any other combination and arrangement, and more generally includes at least two of the air filter units 30 interconnected by at least one of the attachment mechanisms 32. Thus, with the optional embodiments of the present disclosure, an air filter manufacturer may make available for purchase a single sized air filter unit (or a small number of different sizes); an end user can then simply purchase the number of air filter units (and corresponding attachment mechanisms) needed to create an air filter device of desired shape and size.

Assembly of the selected number and arrangement of the air filter units 30 with the corresponding expansion joints 32 can be facilitated in various manners. In some embodiments, one or both of the air filter units 30 and the expansion joints 32 include features that promote mounting of one of the expansion joints 32 to one of the air filter units 30. For example, an adhesive strip can be provided on one or both of the air filter units 30 and the expansion joints 32. Prior to assembly, the adhesive strip can optionally be covered by a release liner. Alternatively, or in addition, one or more mechanical fasteners (e.g., strips of complementary hook-and-loop materials, clamps, etc.) can be provided on or with the air filter units 30, or as part of the kit 200. As should be appreciated, the complementary mechanical fasteners or adhesive strips can also serve as attachment mechanisms to directly connect air filter units. In yet other embodiments, the modular delivery condition can include one (or more) of the expansion joints 32 pre-assembled to one of the air filter units 30. For example, FIG. 5 illustrates an optional arrangement in which a first end 210 of the expansion joint 32z is pre-assembled to the air filter unit 30z. An opposing, second end 212 of the expansion joint 32e is available for mounting to a selected second air filter unit 30 as desired by the end user.

The air filter devices and related methods of use of the present disclosure provide a marked improvement over previous designs. By promoting simple, manual expansion in one or both of the length and width directions, the air filter devices of the present disclosure afford a user the ability to achieve a “best fit” with the air handling device to which the air filter is installed.

### Embodiments

1. An air filter device comprising: first and second air filter units each including filter media; and an attachment mechanism connecting the first air filter unit and the second air filter unit.

2. The air filter device of embodiment 1, wherein the first and second air filter units each include an outer frame assembly.

3. The air filter assembly of embodiment 2, wherein the attachment mechanism comprises a first expansion joint extending between the outer frame assembly of the first air filter unit and the outer frame assembly of the second air filter unit.

4. The air filter device of embodiment 3, wherein the first expansion joint is expandable from a collapsed state to an expanded state.

5. The air filter device of embodiment 4, wherein a distance between the outer frame assembly of the first and second air filter units increases from the collapsed state to the expanded state.

6. The air filter device of any of embodiments 3-5, wherein the first expansion joint includes a sheet of material.

7. The air filter device of embodiment 6, wherein the sheet defines at least one fold line.

8. The air filter device of embodiments 6 or 7, wherein the sheet is pleated.

9. The air filter device of embodiment 6, wherein the sheet includes nonwoven filter media.

10. The air filter device of any of embodiments 5-8, wherein the sheet includes a material selected from the group consisting of a nonwoven media, an elastic material, and a fabric.

11. The air filter device of any of embodiments 3-10, wherein the air filter device is configured to provide: a delivery condition in which the first expansion joint is separated from at least the first air filter unit; and an installation condition in which the first expansion joint is attached to each of the first and second air filter units.

12. The air filter device of embodiment 11, further comprising an engageable fastener configured to selectively attach the first expansion joint to the first air filter unit in transitioning the air filter device from the delivery condition to the installation condition.

13. The air filter device of any of embodiments 3-10, wherein the first expansion joint is permanently attached to the first and second air filter units.

14. The air filter device of any of embodiments 3-13, further comprising: a third air filter unit including a filter media and an outer frame assembly arranged about the perimeter of the filter media of the third air filter unit; and a second expansion joint connected to and extending between the outer frame assembly of the first air filter unit and the outer frame assembly of the third air filter unit.

15. The air filter device of embodiment 14, wherein the second expansion joint is expandable from a collapsed stated to an expanded state.

16. The air filter device of embodiment 15, wherein a distance between the outer frame assembly of the first and the air filter units increases from the collapsed state to the expanded state of the second expansion joint.

17. The air filter device of any of embodiments 14-16, wherein the filter device is configured such that the first and second expansion joints are expandable in differing directions.

18. The filter device of embodiment 17, wherein the first expansion joint is expandable in a first direction and the second expansion joint is expandable in a second direction orthogonal to the first direction.

19. The air filter device of any of embodiments 14-18, further comprising: a fourth air filter unit including a filter media and an outer frame assembly arranged about the perimeter of the filter media of the fourth air filter unit; and a third expansion joint connected to and extending between the outer frame assembly of the second air filter unit and the outer frame assembly of the fourth air filter unit.

20. The air filter device of embodiment 19, further comprising: a fourth expansion joint connected to and extending between the outer frame assembly of the third air filter unit and the outer frame assembly of the fourth air filter unit.

21. The air filter device of embodiment 20, wherein the first expansion joint is aligned with the fourth expansion joint, and the second expansion joint is aligned with the third expansion joint.

22. The air filter device of either of embodiments 20 or 21, further comprising: a patch member interconnecting the first-fourth expansion joints.

23. The air filter device of any of embodiments 1-22, further comprising: exterior framework selectively retaining the first air filter unit relative to the second air filter unit at a selected distance.

24. The air filter device of embodiment 23, wherein the first expansion joint extends continuously between the first and second air filter units when the first and second air filter units are arranged at the selected distance.

25. The air filter device of either of embodiments 23 or 24, wherein the framework contacts a portion of the outer frame assembly of each of the first and second air filter units.

26. The air filter device of any of embodiments 23-25, wherein the framework includes a first member connected to the first air filter unit and a second member connected to the second air filter unit, and further wherein the first member is slidably connected with the second member.

27. The air filter device of embodiment 26 wherein the framework further includes a locking mechanism for selectively locking the first member relative to the second member.

28. The air filter device of any of embodiments 1-27, wherein the filter media assembly of each of the first and second air filter units includes a pleated filter media defining the corresponding perimeter as opposing first and second end edges, and opposing first and second side edges, and further wherein the outer frame assembly of each of the first and second air filter units includes opposing first and second end frame structures, and opposing first and second side frame structures, and even further wherein the first and second air filter units each include the first and second end frame structures fixed to the corresponding, first and second end edges, respectively, and the first and second side frame structures fixed to the corresponding first and second side edges, respectively.

29. The air filter device of embodiment 28 wherein the first side frame structure of the first air filter unit faces the second side frame structure of the second air filter unit, and further wherein the first expansion joint is directly connected to the first side frame structure of the first air filter unit and the second side frame structure of the second air filter unit.

30. A method of installing an air filter device to an air handling device with an air filter compartment having a size, the method comprising: receiving an air filter device in a collapsed state, the air filter device including: first and second air filter units each including: a filter media, an outer frame assembly arranged about a perimeter of the filter media, and a first expansion joint connected to and extending between the outer frame assembly of the first air filter unit and the outer frame assembly of the second air filter unit; expanding the air filter device from the collapsed state to an expanded state corresponding with the evaluated size, wherein the step of expanding includes transitioning the first air filter unit away from the second air filter unit, and expanding the first expansion joint; and inserting the air filter device in the expanded state into the air filter compartment.

31. The method of embodiment 30, wherein the step of expanding includes unfolding the first expansion joint.

32. The method of either of embodiments 30 or 31, wherein a spatial arrangement of the outer frame assembly of the first air filter unit relative to the filter media of the first air filter unit does not change with the step of expanding.

33. The method of any of embodiments 30-32, wherein prior to the step of receiving the air filter device in the collapsed state, the method further comprising: attaching the first expansion joint to the first air filter unit.

34. The method of any of embodiments 30-33, wherein the air filter device further includes a third air filter unit connected to the first air filter unit by a second expansion joint, and wherein the step of expanding further includes: transitioning the third air filter unit away from the second air filter unit, and expanding the second expansion joint.

35. The method of any of embodiments 30-34, wherein following the step of expanding and prior to the step of inserting, the method further comprising: locking an exterior framework relative to the first and second air filter units to secure the air filter device in the expanded state.

36. The method of any of embodiments 30-35, and further comprising evaluating the size of the air filter compartment provided with the air handling device.

Although the present disclosure has been described with reference to preferred embodiments, workers skilled in the art will recognize that changes can be made in form and detail without departing from the spirit and scope of the present disclosure.

1. An air filter device comprising:
first and second air filter units each including filter media; and
an attachment mechanism connecting the first air filter unit and the second air filter unit.

2. The air filter device of claim 1, wherein the first and second air filter units each include an outer frame assembly, and wherein the attachment mechanism comprises a first expansion joint extending between the outer frame assembly of the first air filter unit and the outer assembly of the second air filter unit.

3. The air filter device of claim 2, wherein the first expansion joint is expandable from a collapsed state to an expanded state.

4. The air filter device of claim 3, wherein the first expansion joint includes a sheet of material.

5. The air filter device of claim 4, wherein the sheet includes a material selected from the group consisting of a nonwoven filter media, an elastic material, and a fabric.

6. The air filter device of claim 1, wherein the air filter device is configured to provide:
a delivery condition in which the first expansion joint is separated from at least the first air filter unit; and
an installation condition in which the first expansion joint is attached to each of the first and second air filter units.

7. The air filter device of claim 2, further comprising an engageable fastener configured to selectively attach the first expansion joint to the first air filter unit in transitioning the air filter device from the delivery condition to the installation condition.

8. The air filter device of claim 2, further comprising:
a third air filter unit including a filter media and an outer frame assembly arranged about the perimeter of the filter media of the third air filter unit; and
a second expansion joint connected to and extending between the outer frame assembly of the first air filter unit and the outer frame assembly of the third air filter unit.

9. The air filter device of claim 8, wherein the filter device is configured such that the first and second expansion joints are expandable in differing directions.

10. The air filter device of claim 8, further comprising:
a fourth air filter unit including a filter media and an outer frame assembly arranged about the perimeter of the filter media of the fourth air filter unit; and
a third expansion joint connected to and extending between the outer frame assembly of the second air filter unit and the outer frame assembly of the fourth air filter unit.

11. The air filter device of claim 10, further comprising:
a patch member interconnecting the first-fourth expansion joints.

12. The air filter device of claim 1, further comprising:
exterior framework selectively retaining the first air filter unit relative to the second air filter unit at a selected distance.

13. The air filter device of claim 12, wherein the framework includes a first member connected to the first air filter unit and a second member connected to the second air filter unit, and further wherein the first member is slidably connected with the second member.

14. The air filter device of claim 1, wherein the filter media assembly of each of the first and second air filter units includes a pleated filter media defining the corresponding perimeter as opposing first and second end edges, and opposing first and second side edges, and further wherein the outer frame assembly of each of the first and second air filter units includes opposing first and second end frame structures, and opposing first and second side frame structures, and even further wherein the first and second air filter units each include the first and second end frame structures fixed to the corresponding, first and second end edges, respectively, and the first and second side frame structures fixed to the corresponding first and second side edges, respectively.

15. A method of installing an air filter device to an air handling device having an air filter compartment with a size, the method comprising:
receiving an air filter device in a collapsed state, the air filter device including:
first and second air filter units each including:
a filter media,
an outer frame assembly arranged about a perimeter of the filter media, and
a first expansion joint connected to and extending between the outer frame assembly of the first air filter unit and the outer frame assembly of the second air filter unit;
expanding the air filter device from the collapsed state to an expanded state corresponding with the compartment size, wherein the step of expanding includes transitioning the first air filter unit away from the second air filter unit, and expanding the first expansion joint; and
inserting the air filter device in the expanded state into the air filter compartment.

16. The method of claim 15, wherein a spatial arrangement of the outer frame assembly of the first air filter unit relative to the filter media of the first air filter unit does not change with the step of expanding.

17. The method of claim 15, wherein prior to the step of receiving the air filter device in the collapsed state, the method further comprising:
attaching the first expansion joint to the first air filter unit.
